(19) United States
(12) Patent Application Publication
(10) Pub. No.: US 2025/0184990 A1
(43) Pub. Date: Jun. 5, 2025

(54) USER EQUIPMENT, ESPECIALLY NEW RADIO USER EQUIPMENT AND CORRESPONDING METHOD

(71) Applicant: Fraunhofer-Gesellschaft zur Förderung der angewandten Forschung e.V., München (DE)

(72) Inventors: Thomas FEHRENBACH, Berlin (DE); Sarun SELVANESAN, Berlin (DE); Baris GÖKTEPE, Berlin (DE); Thomas WIRTH, Berlin (DE); Thomas SCHIERL, Berlin (DE); Cornelius HELLGE, Berlin (DE)

(21) Appl. No.: 19/051,809

(22) Filed: Feb. 12, 2025

Related U.S. Application Data
(63) Continuation of application No. PCT/EP2023/071994, filed on Aug. 9, 2023.

(30) Foreign Application Priority Data
Aug. 12, 2022 (EP) 22190265.3

(51) Int. Cl. H04W 72/12; H04W 72/542; H04W 88/06

(52) U.S. Cl. CPC H04W 72/1215; H04W 72/542; H04W 88/06

(57) ABSTRACT

User equipment, especially NR user equipment, having a transceiver configured for NR communication using an NR resource pool, wherein the transceiver is configured to adapt scheduling for a part of the NR resource pool, wherein adapting the scheduling is performed according to an adaption technique.

### CROSS-REFERENCE TO RELATED APPLICATIONS

This application is a continuation of copending International Application No. PCT/EP2023/071994, filed Aug. 9, 2023, which is incorporated herein by reference in its entirety, and additionally claims priority from European Application No. 22190265.3, filed Aug. 12, 2022, which is also incorporated herein by reference in its entirety.

### TECHNICAL FIELD

Embodiments of the present invention refer to user equipment, especially a NR user equipment. Further embodiments refer to a method for performing NR communication.

In general, embodiments of the present invention refer to an aspect for performing communication using a NR user equipment in a shared resource pool (e.g., a shared with LTE).

### BACKGROUND OF THE INVENTION

FIG. 4(a) is a schematic representation of an example of a terrestrial wireless network 100 including, as is shown in FIG. 4(a), the core network 102 and one or more radio access networks RAN₁, RAN₂, . . . RAN_{N}. FIG. 4(b) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 4(b) shows an exemplary view of five cells, however, the RANₙ may include more or less such cells, and RANₙ may also include only one base station. FIG. 4(b) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 4(b) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 1121. The device 1102 accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 4(b) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 4(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSCCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st} stage SCI, and optionally, a second control region which contains a second part of control information, also referred to as the 2^{nd} stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 4 may be a heterogeneous network having distinct overlaid networks, e.g., a network of macro cells with each macro cell including a macro base station, like base station gNB₁ to gNB₅, and a network of small cell base stations, not shown in FIG. 4, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 4, for example in accordance with the LTE-Advanced Pro standard or the 5G or NR, new radio, standard.

In mobile communication networks, for example in a network like that described above with reference to FIG. 4, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 4. This is referred to as an “in-coverage” scenario. Another scenario is referred to as an “out-of-coverage” scenario. It is noted that “out-of-coverage” does not mean that the two UEs are not within one of the cells depicted in FIG. 4, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5/PC3 interface, one of the UEs may also be connected with a BS, and may relay information from the BS to the other UE via the sidelink interface and vice-versa. The relaying may be performed in the same frequency band, in-band-relay, or another frequency band, out-of-band relay, may be used. In the first case, communication on the Uu and on the sidelink may be decoupled using different time slots as in time division duplex, TDD, systems.

FIG. 5 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 4. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 6 is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 6 which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 5, in addition to the NR mode 1 or LTE mode 3 UEs 202, 204 also NR mode 2 or LTE mode 4 UEs 206, 208, 210 are present. In addition, FIG. 6, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210

Although FIG. 5 and FIG. 6 illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

New radio and LTE, especially the two C-V2X technologies, namely LTE-V2X and NL-V2X, may sometimes use the same resources.

### OBJECTIVE

Therefore it is an objective of the present invention to provide a concept for efficiently sharing resources between two different communication technologies/networks, for example NR and LTE.

Before discussing the solution, the background will be discussed and especially discussed with regard to its drawbacks. The analysis of the background and the identification of the drawbacks is part of the disclosure of the invention and, thus, is not to be interpreted as known technology.

As mentioned above, there are two C-V2X technologies namely LTE-V2X and NR-V2X. Operating both on separate orthogonal (in time and/or frequency) resources has some obvious drawbacks.

A static distribution of resources may lead to resources by one technology being unused while more resources are required for the other technology. Also, there will be a shift over time from LTE to NR making the required resources for LTE less and less. However, the pool size of LTE still needs to be large enough to cover the maximum demand. This will leave a lot of resources unused or rarely used.

### SUMMARY

An embodiment may have user equipment, especially NR user equipment, having a transceiver configured for NR communication using an NR resource pool, wherein the transceiver is configured to adapt scheduling of resources for a transmission for a part of the NR resource pool, wherein adapting the scheduling of resources for the transmission is performed according to an adaption technique.

Another embodiment may have user equipment, especially NR user equipment, having a transceiver configured for NR communication using an NR resource pool, wherein the transceiver is configured to perform LTE sensing (e.g. of potential/future transmissions or past collisions) and to inform an internal NR transceiver of the transceiver using interchange coordination or an external NR transceiver using IUC message or broadcasting.

Another embodiment may have a communication system having user equipment according to the invention as mentioned above using NR resource pool.

According to another embodiment, a method for performing NR communication using an NR resource pool may have the following step: adapting a scheduling for a part of the NR resource pool, wherein adapting the scheduling is performed according to an adaption technique.

Another embodiment may have a non-transitory digital storage medium having stored thereon a computer program for performing a method for performing NR communication using an NR resource pool, having the step of: adapting a scheduling for a part of the NR resource pool, wherein adapting the scheduling is performed according to an adaption technique, when the computer program is run by a computer.

An embodiment provides a user equipment, especially a new radio user equipment, comprising a transceiver configured for new radio communication using a new radio resource pool, wherein the transceiver is configured to adapt (or restrict) a schedule for a part of the new radio resource pool, wherein adapting the scheduling is performed according to an adaption technique. According to an embodiment, said part of the NR resource pool overlaps to a LTE resource pool or, in general, a resource pool of another communication network.

Embodiments of the present invention are based on the finding, that by dynamically adapting or restricting an NR resource pool a better use of resources can beneficially achieve by dynamically sharing of between LTE- and NR-V2X. To achieve this, collisions between both communication networks are avoided.

Another embodiment provides a method for performing NR communication using NR resource pool. The method comprises the step adapting a scheduling for a part of the NR resource pool, wherein adapting the scheduling is performed according to an adaption technique.

According to further embodiments the method can be computer implemented.

### BRIEF DESCRIPTION OF THE DRAWINGS

FIG. 1 shows schematically a resource pool which can be shared in frequency and/or time according to embodiments;

FIG. 2 shows a block diagram for illustrating embedded sharing (resource pools can be embedded in another resource pool according to embodiments);

FIGS. 3a, b and c show schematic block diagrams of modem setups to be used in user equipments according to embodiments;

FIGS. 4a, b show schematic representations of an example of a terrestrial network to illustrate background of the embodiment;

FIG. 5 shows a schematic representation of an in coverage scenario;

FIG. 6 shows a schematic representation of out of coverage scenario; and

FIG. 7 shows schematically a computer system to be used in context of embodiments.

### DETAILED DESCRIPTION OF THE INVENTION

Below, embodiments of the present invention will subsequently be discussed referring to the enclosed figures, wherein identical reference numbers are provided to objects that have an identical or of similar function, so that description thereof is interchangeable and mutually applicable.

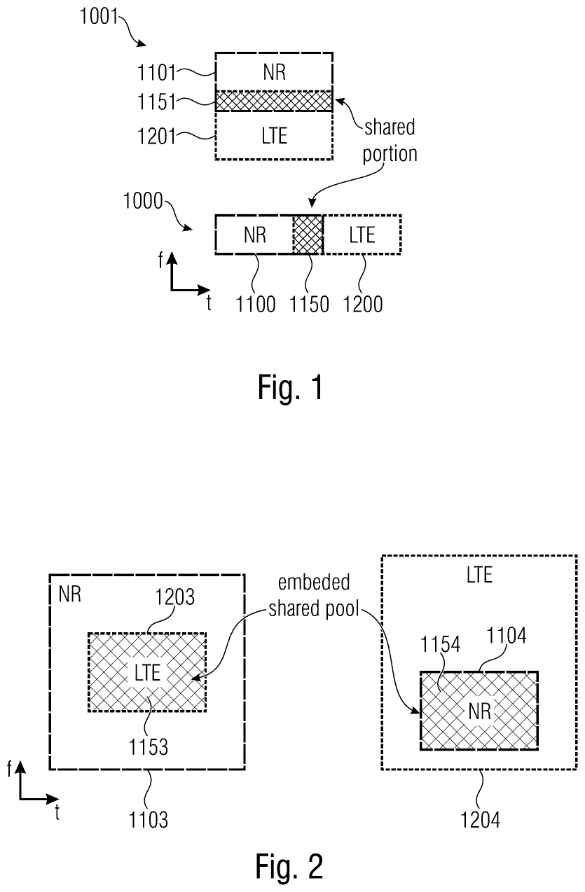

FIG. 1 shows two different resource pools 1000 and 1001 which comprise a NR portion 1100 and 1101 and a LTE portion 1200 and 1201. As it is illustrated, the two portions can be arranged across different time portions (cf. 1100 and 1200) and/or frequency portions (cf. 1101 and 1201). For both illustrated resource pools 1000 and 1001 the NR resource pool 1100/1101 and the LTE resource pool 1200/1201 comprises an overlap to the respective other resource pool which is marked by the reference numeral 1150 and 1151. This overlap is also referred to as shared portion.

It should be noted that this concept is not limited to the overlap of the two resource pools 1150 and 1151 for new radio and LTE, so it can also be used for area overlap of two different communication technologies/communication standards, where the respective resource portions 1100/1101 and 1200/1201 overlap or partially overlap each other.

FIG. 2 shows another principle scenario showing two respective resource pools 1103 and 1203 and 1104 and 1204 respectively, where one resource pool is completely embedded into the other. In the one example, the resource pool for new radio 1103 defined by time and frequency is substantially larger than the LTE resource 1203, so that a so-called embedded shared resource pool 1153 is formed. In the other example, the LTE resource pool 1204 plotted over frequency and time is substantially larger than the new radio resource pool 1104, so that the entire new radio resource pool 1104 is embedded as embedded shared pool 1154.

Since the influence to LTE resource pools (1200, 1201, 1203, and 1204) is limited, it is composed according to embodiments of the present invention to add up a scheduling for a path 1150, 1151, 1153, 1154 for the new radio resource pool 1100, 1101, 1103 and 1104. Thus, an embodiment provides a method for performing new radio communication using an NR resource pool 1100, 1101, 1103 and 1104. This method comprises the main step adapting a scheduling for a part 1150, 1151, 1153 and 1154 of the new radio resource pool 1100, 1101, 1103 and 1104, wherein adapting the scheduling is performed according to an adaption technique. According to an embodiment adapting means restricting the part 1150, 1151, 1153 and 1154. According to embodiments the part 1150, 1151, 1153 and 1154 which overlaps to a LTE resource pool 1200, 1201, 1203 and 1204 is adapted.

Another embodiment provides a user equipment, especially a NR user equipment comprising a transceiver considered for NR communication using an NR resource pool 1100, 1101, 1103, 1104. Here the transceiver is configured to adapt scheduling for a part 1150, 1151, 1153, 1154 of the new radio resource pool 1100, 1101, 1103, 1104, wherein adapting the scheduling is performed according to an adaption technique.

Background of the embodiments is that NR modem may be restricted in its scheduling freedom in case an overlap with an LTE RP is detected. Therefore, according to further embodiments the transceiver/new radio modem may perform LTE sensing or LTE RSRP sensing. According to embodiments the adaption technique, e.g., the restricting as part of the adaption technique or a reselecting as part of the adaption technique is performed dependent on the LTE sensing or LTE RSRP sensing. For example, the scheduling restrictions may affect only the overlapping paths 1150, 1151, 1153, 1154 of the RPs or the whole RPs for which an overlap is detected. Below, different adaption techniques will be discussed. According to embodiments, the adaption techniques may comprise one of the following:
adapting the resource reselection counter;
adapting resource reservation periodicity;
deactivating certain resources and/or resources belonging to a certain periodicity.

According to embodiments one of the three above mentioned adaption techniques or a combination of two or more of the adaption techniques may be used.

### Resource Reselection Counter

Lower the resource reselection counter to re-evaluate if the resources are still available and/or reselect new resources as an LTE UE will not be aware of the NR transmission. This can be done dynamically depending on a criterion (e.g. lower the reselection counter when more LTE UEs are detected). Or it can be configured or preconfigured. The reselection counter can be adapted by changing the range the random number is drawn from:

$$3 > randomly select , with equal probability , an integer value in the interval [ 5 , 15 ] for the resource reservation internal higher than or equal to 10 ms or in the interval [ 5 \times ⌈ \frac{100}{max ( 20 , {P}_{rsvp \_ TX} )} ⌉ , 15 \times ⌈ \frac{100}{max ( 20 , {P}_{rsvp \_ TX} )} ⌉ ] for the resource reservation interval lower than 100 ms and set \vert SL\_RESOURCE \_RESELECTION \_COUNTER to the selected value ;$$

One way to achieve this is to apply one or more adaption factors r to the formula.

In general, this means that according to embodiments the user equipment may perform an adaption technique comprising an adapting or lowering resource reselection counter. For example, the adapting and/or lowering may comprise changing a range from which random numbers for a resource reservation intervals are drawn.

### Adaption Resource Reservation Periodicities—Restrict M2 Scheduling in Shared Pools to LTE Periodicity

According to embodiments: The NR modem may determine or receive LTE periodicities which are used in an overlapping LTE RP. Then the NR modem may restrict to periodicities for periodic transmissions that are also used for LTE. This allows an LTE device to sense and predict NR periodic traffic correctly. Otherwise, different priorities would cause an LTE device to predict future transmissions incorrectly. Furthermore, a periodicity such that at least one of the LTE periodicities is a multiple of said periodicity may also be supported. This mode requires good LTE sensing information to avoid consecutive periodic resource collisions.

In general, the adaption technique and/or restricting as part of adaption technique and/or reselecting as part of adaption technique is performed dependent on one or more of the following criteria:
Presence/absence of LTE sensing information,
Number of negative HARQ feedback received,
Reception of collision indicators,
Resource pool configurations received from a gNB,
Reception of IUC messages that take into account LTE sensing information.

In general, this means that the user equipment may be adapted to a formal adaption technique comprising adapting resource reservation periodicity to LTE periodicity. According to further embodiments, the LTE periodicity may be determined and then the adaption of resource reservation periodicity dependent on the determined LTE periodicity may be performed.

### Adaption Resource Reservation Periodicity—Restricting M2 Scheduling in Shared Pools to a Non-LTE Periodicity

According to embodiments, the NR modem may try to avoid consecutive periodic resource collision with LTE by only choosing or being configured to only select certain periodicities. For example, periodicities that have a common multiple of LTE periodicities can be avoided. The downside here is that it is hard to avoid all collisions with LTE. However, the collisions in this case are not consecutively colliding with the same LTE UE.

In general, this means that according to embodiments the UE may perform an adaption technique comprising adapting resource reservation periodicity to a non-LTE periodicity or to only certain periodicities not used for the respective communication network/for LTE.

### Deactivate a Periodic or Periodic Transmissions

According to embodiments, An NR modem may refrain from using aperiodic or periodic transmissions in a shared RP or in shared parts of an RP. Aperiodic traffic cannot be predicted by LTE devices. Hence, aperiodic NR transmissions increase the collision probability significantly in shared parts of a RP.

In general, this means that according to embodiments the user equipment may perform an adaption technique comprising deactivating a periodic transmission or deactivating a periodic transmission.

### Deactivate Transmissions in Shared Pools

According to embodiments an NR mode may avoid shared parts (1150, 1151, 1153, 1154) or an RP in order to not cause interference to other LTE devices.

### Include LTE RSRP Sensing in M2 Candidate Resource Selection

According to an embodiment, an NR modem may consider the LTE RSRP measurements for its own resource selection. It may consider a resource as occupied, if the LTE RSRP is above a certain threshold. This way it can avoid collisions with LTE devices.

According to embodiments, the shared parts (cf. deactivate transmissions in shared parts) may be deactivated based on the LTE/LTE RSRP measurements. Note, according to embodiments, the new radio transceiver may perform the sensing/measurement by itself or may get access to sensing/measurement results, for example, this is the so-called collision indication from further UEs. According to embodiments, the adaption technique and/or restricting as part of the adaption technique and/or reselecting as part of the adaption technique is performed dependent on feedback from another UE detecting a collision or on information received from another UE. For example, in case of a collision a further UE can sense and indicate the collision to the transmitting UE.

### Reselection Resource Depending on PSFCH Feedback

According to embodiments, the adaption technique and/or restricting as part of adaption techniques and/or reselecting as part of adaption techniques is performed dependent on a determined PSFCH feedback. For example, in case of reaching a pre-configured negative HARQ feedbacks threshold a resource reselection is triggered.

According to another embodiment, the adaption technique may be performed based on or taking into account information out of pre-configuration or information from a gNB, like DCI, MAC or RRC signaling.

In another embodiment, the previously stated restrictions may only be applied to certain traffic/packets based on one or more criteria:
L1 and/or L2 priority, e.g. apply restriction to low priority traffic but not high priority
Cast-type, e.g. unicast, groupcast, broadcast
QoS profile (e.g. PQI, Packet delay budget, . . . )
HARQ based or blind transmission (PSFCH might not be present in shared resources)
L1 and/or L2 destination ID
Initial transmission or retransmission
Is relayed traffic or non-relayed traffic
periodicity
CBR, e.g. total CBR (Amount of overall resource usage) or LTE CBR (Amount of resource used by LTE transceivers) or NR CBR (Amount of resource used by NR transceivers)

In general, this means that, according to embodiments, the adaption technique comprises restrictions applied depending on one or more of the following criterion:
L1 and/or L2 priority;
cast type;
QOS profile;
HARQ based on blind transmission;
L1 and/or L2 destination IT;
initial transmission or retransmission;
relay traffic or nonrelated traffic;
periodicity; and/or
CBR, total CBR, LTE CBR or an NR CBR.

Note, according to embodiments, shared pool configuration/detection may be used as input for the adaption technique. For example, a transceiver can be pre-configured to obtain RRC configurations from gNB which include one or more of the following:

Shared pool as part of RP config or separate LTE RP config (NR UE detects overlap or LTE V2X co-existence assistance information)
Pool can be fully or partially overlapping
   i. Shared parts of pool can be restricted to certain priorities and/or periodicities and/or aperiodic messages
   ii. Used only if a certain threshold is reached: e.g. NR.CBR above certain threshold or LTE-CBR below a certain threshold
   iii. Avoided if LTE CBR exceeds a certain threshold

A pre-configured priority to be used for sensed LTE resources.

More than one pre-configured priority to be used for sensing LTE resources depending on one or more criteria (e.g. depending on the NR transmission priority or CBR).

In general, this means that the transfer may be configured to use the adaption technique based on pool configurations or pool pre-configurations. For this, the transceiver may extract information out of the configuration information so as to form/select the adaption technique. An exemplary RRC configuration is shown below:

### SL-BWP-PoolConfig

The IE SL-BWP-PoolConfig is used to configure NR sidelink communication resource pool.

SL-BWP-PoolConfig information element

```
    ▪ ASN1START
    ▪ TAG-SL-BWP-POOLCONFIG-START
```

| | |
|---|---|
| SL-BWP-PoolConfig-r16 ::= | SEQUENCE { |

| | |
|---|---|
| sl-RxPool-r16 | SEQUENCE (SIZE (1..maxNrofRXPool-r16)) OF SL-ResourcePool- |

r16 OPTIONAL, -- Cond HO

| | | |
|---|---|---|
| sl-TxPoolSelectedNormal-r16 | SL-TxPoolDedicated-r16 | OPTIONAL, -- |

Need M

| | | |
|---|---|---|
| sl-TxPoolScheduling-r16 | SL-TxPoolDedicated-r16 | OPTIONAL, -- |

Need N

| | | |
|---|---|---|
| sl-TxPoolExceptional-r16 | SL-ResourcePoolConfig-r16 | OPTIONAL -- |

Need M
}

| | |
|---|---|
| SL-TxPoolDedicated-r16 ::= | SEQUENCE { |

| | |
|---|---|
| sl-PoolToReleaseList-r16 | SEQUENCE (SIZE (1..maxNrofTXPool-r16)) OF SL-ResourcePoolID- |

r16 OPTIONAL, -- Need N

| | |
|---|---|
| sl-PoolToAddModList-r16 | SEQUENCE (SIZE (1..maxNrofTXPool-r16)) OF SL- |

ResourcePoolConfig-r16 OPTIONAL -- Need N
}

| | |
|---|---|
| SL-LTE-TxPool-r18 ::= | SEQUENCE { |

| | |
|---|---|
| LTE-PoolToReleaseList-r18 | SEQUENCE (SIZE (1..maxNrofLTEPool-r18)) OF LTE- |

ResourcePoolID-r18 OPTIONAL, -- Need N

| | |
|---|---|
| LTE-PoolToAddModList-r18 | SEQUENCE (SIZE (1..maxNrofLTEPool-r18)) OF SL- |

```
ResourcePoolConfig-r18 OPTIONAL -- Need N
  }
  SL-LTE-Coexistance-Config SEQUENCE {
```

| | | |
|---|---|---|
| LTE-PoolToReleaseList-r18 | LTE-ResourcePoolID-r18 | OPTIONAL, -- Need N |

| | | |
|---|---|---|
| NR-SL-Tx-paramsToAddModList-r18 | NR-SL-Tx-params | OPTIONAL, -- Need N |

SL-ResourcePoolConfig-r16 ::= SEQUENCE {

| sl-ResourcePoolID-r16 | SL-ResourcePoolID-r16, | |
|---|---|---|
| sl-ResourcePool-r16 | SL-ResourcePool-r16 | OPTIONAL -- Need |

M
}

| | |
|---|---|
| SL-ResourcePoolID-r16 ::= | INTEGER (1..maxNrofPoolID-r16) |

NR-SL-Tx-params SEQUENCE {

| | |
|---|---|
| prioTx-allow, | ENUM. (0...8) |
| prioTx-deny, | ENUM. (0...8) |
| allowedPeriodicities | LIST (1ms,2ms,7ms,5ms,100ms,250ms...) |
| deniedPeriodicities | LIST (10ms,20ms,30ms,50ms,100ms,250ms...) |
| CBR-threshold | ENUM. (10,20,30,40,50,60,70,80,95,...) |

```
  reselCounter
    ▪ TAG-SL-BWP-POOLCONFIG-STOP
    ▪ ASN1STOP
```

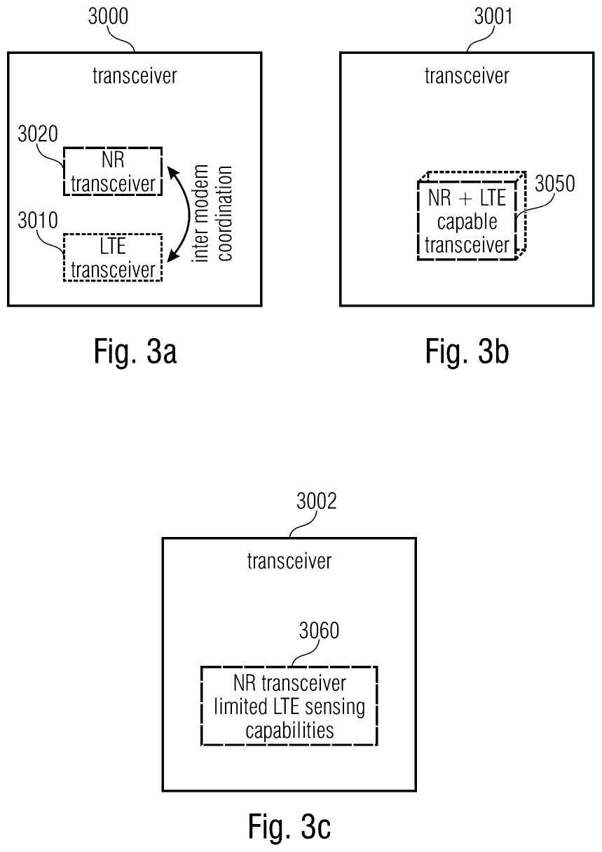

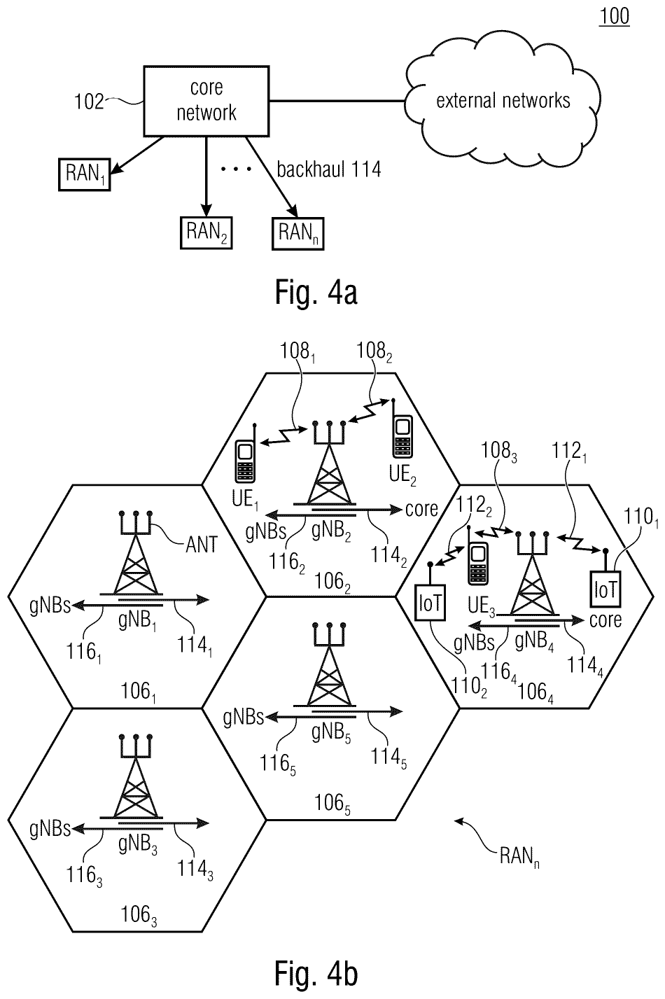

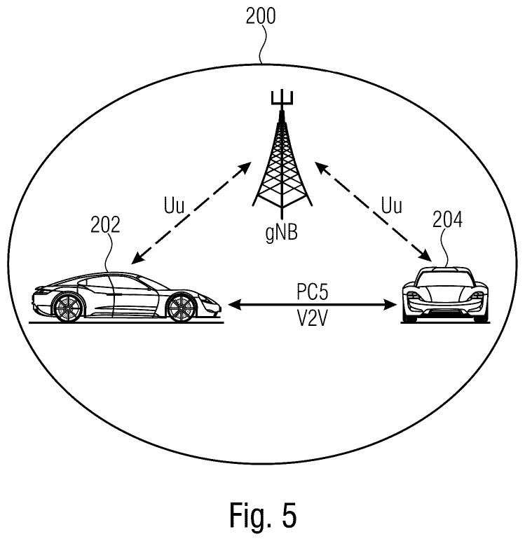

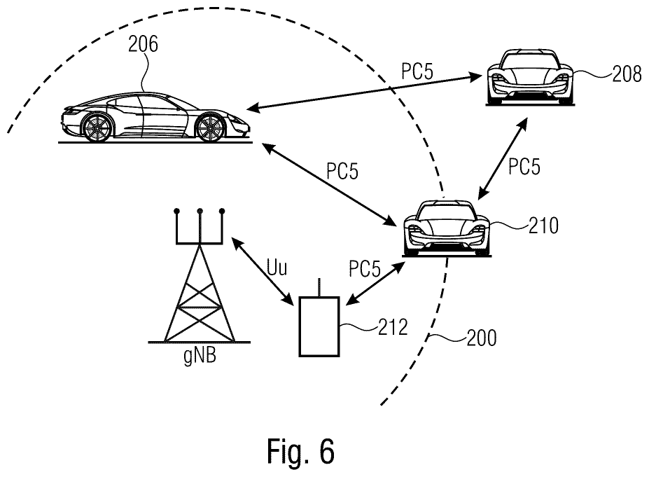

With respect to FIGS. 3a, 3b and 3c, different transceivers 3000, 3001 and 3002 are shown. The transceiver 3000 of FIG. 3a comprises an LTE transceiver 3020 and NR transceiver 3010. The LTE transceiver 3020 may be used for performing LTE sensing. Both transceiver 3010 and 3020 interchange information by use of inter modem coordination messages.

The transceiver 3001 of FIG. 3b comprises a full blown NR+LTE capable transceiver 3050. Here, the LTE sensing can be performed internally by this transceiver 3050.

The transceiver 3002 of FIG. 3c comprises an NR transceiver 3060 which has limited LTE sensing capabilities. Thus, the transceiver 3060 may perform the LTE sensing. Thus, according to embodiments, the transceiver may perform the adaption technique based on LTE sensing information obtained by another transceiver unit 3020 or an internal transceiver 3050 and 3060 capable of LTE sensing.

According to embodiments, to be aware of LTE transmission a NR modem can obtain information in one or more of the following methods.

An example is the above mentioned LTE sensing/the usage of the LTE sensing information.

Sensing information can be obtained as assistance information coming from a separate LTE sensing capable modem (e.g. as a Resource Usage Bitmap) or a AIM (preferred/non-preferred resource set).
Handle LTE assistance information as an internal inter-UE coordination information.
Either obtained by a LTE and NR capable UE or a co-located LTE UE.

Furthermore, other information such as the priority of LTE transmissions or the CBR of the shared pool can be reported to the NR transceiver.

Additionally or alternatively, the LTE sensing may be performed externally, e.g., by another transceiver of another user equipment or a transceiver of another network entity, like the gNB. Thus, according to embodiments, NR and LTE capable transceiver takes LTE sensing into account to inform a further UE about a potential future or past collision. This can be used by the further UE to perform a resource reselection taking the IUC into account and avoiding the occupied resources.

According to a further embodiment, the transceiver can include LTE sensing into account for IUC messages when determining a set of preferred and/or non-preferred resources.

This can be included even when sending IUC messages to legacy UEs (such as NR Rel. 17 UEs) which are not aware of LTE traffic.

In general, according to the user equipment/NR user equipment, it should be noted that same may comprise at least limited LTE sensing capabilities according to an embodiment. For example, the UE may comprise NR+LTE transceiver or an NR transceiver unit and an LTE transceiver unit which may be configured to exchange information using interchange coordination. According to embodiments, the transceiver may be configured for LTE sensing (e.g., of potential/future transmissions/collisions) and to inform an internal NR transceiver unit of the transceiver using interchange coordination.

Another embodiment refers to a user equipment without the adaption technique which comprise the at least limited sensing. Here, the three possibilities NR+LTE transceivers or LTE transceiver unit in combination with NR transceiver unit and NR transceiver unit with limited LTE sensing unit are possible.

Further an UE or RSU can broadcast inter-UE coordination messages to avoids LTE traffic. (non-preferred sets) and/or send post collision indication between LTE/NR transmissions.

In general, according to embodiments, an external NR transceiver can be informed using IOC message or broadcasting.

In a further embodiment the UE can receive an LTE resource usage map from another transceiver such as a further UE, RSU, GL UE or gNB.

Furthermore, other information such as the priority of LTE transmissions or the CBR of the shared pool can be reported.

According to embodiments, the transceiver is configured for NR communication using an NR resource pool, wherein the transceiver is configured for LTE sensing and to inform an internal NR transceiver of the transceiver using interchange coordination or an external NR transceiver using IOC message or broadcasting.

### General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a maritime vehicle or a sub-maritime vehicle or a space-borne vehicle, or a combination thereof.

In accordance with embodiments, the user device, UE, described herein may be one or more of a power-limited UE, or a hand-held UE, like a UE used by a pedestrian, and referred to as a Vulnerable Road User, VRU, or a Pedestrian UE, P-UE, animal tracking UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a vehicular UE, or a vehicular group leader, GL, UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

The base station, BS, described herein may be implemented as mobile or immobile base station and may be one or more of a macro cell base station, or a small cell base station, or a central unit of a base station, or a distributed unit of a base station, or an Integrated Access and Backhaul, IAB, node, or a road side unit, or a UE, or a group leader, GL, or a relay, or a remote radio head, or an AMF, or an SMF, or a core network entity, or mobile edge computing entity, or a network slice as in the NR or 5G core context, or a WiFi AP STA, e.g., 802.11ax or 802.11be, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

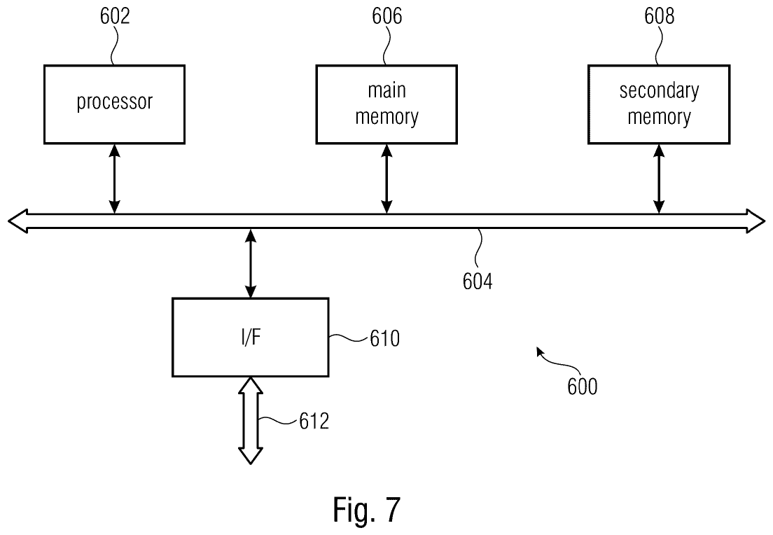

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 7 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier, or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. User equipment, especially NR user equipment, comprising a transceiver configured for NR communication using an NR resource pool, wherein the transceiver is configured to adapt scheduling of resources for a transmission for a part of the NR resource pool, wherein adapting the scheduling of resources for the transmission is performed according to an adaption technique.

2. User equipment according to claim 1, wherein said part is overlapping with a LTE resource pool or a resource pool of another communication network.

3. User equipment according to claim 1, wherein the adaption technique comprises one or the following techniques:
adapting the resource reselection counter;
adapting resource reservation periodicity;
deactivating certain resources and/or resources belonging to a certain periodicity, and/or
wherein adaption technique and/or restricting as part of adaption technique and/or reselecting as part of adaption technique is performed dependent on one or more of the following criteria:
Presence/absence of LTE sensing information,
Number of negative HARQ feedback received,
Reception of collision indicators,
Resource pool configurations received from a gNB,
Reception of IUC messages that take into account LTE sensing information.

4. User equipment according to claim 1, wherein the adaption technique comprises adapting or lowering resource reselection counter which is used to trigger a resource reselection for a periodic transmission; and/or
wherein adapting and/or lowering comprises changing a range from which random numbers for the resource reselection counter are drawn; and/or
wherein the range parameter of the transmission is dependent on the resource reservation interval used for the periodic transmission.

5. User equipment according to claim 1, wherein the adaption technique comprises adapting the resource reservation periodicities (e.g. that are configured to be used in the NR resource pool or the shared portion of the NR resource pool) to LTE periodicities (e.g. pre-configured for the LTE resource pool) or determining LTE periodicities (e.g. by sensing the currently used periodicities for LTE transmissions) and adapting resource reservation periodicity dependent on determined LTE periodicity.

6. User equipment according to claim 1, wherein the adaption technique comprises adapting resource reservation periodicity to non-LTE periodicity or to only certain periodicities not used for LTE, and/or
wherein the adaption technique comprises deactivating periodic transmission or deactivating aperiodic transmission, and/or
wherein adaption technique and/or restricting as part of adaption technique and/or reselecting as part of adaption technique is performed dependent on LTE sensing or LTE RSRP sensing.

7. User equipment according to claim 1, wherein the transceiver is configured to perform LTE sensing or LTE RSRP sensing or energy measurement or to receive information regarding LTE measurements/LTE RSRP measurements.

8. User equipment according to claim 1, wherein adaption technique and/or restricting as part of adaption technique and/or reselecting as part of adaption technique is performed dependent on a determined PSFCH feedback.

9. User equipment according to claim 1, wherein adaption techniques and/or restricting as part of adaption technique and/or reselecting as part of adaption technique is performed dependent on feedback from another UE (e.g. detecting a collision or failed decoding), or on information received from another UE, and/or
wherein adaption techniques and/or restricting as part of adaption technique and/or reselecting as part of adaption technique is performed dependent on receiving a collision indication or IUC message from another UE.

10. User equipment according to claim 1, wherein adaption technique is performed based on or taking into account information out of a pre-configuration or information from a gNB (e.g DCI, MAC or RRC signaling).

11. User equipment according to claim 1, wherein adaption technique is based on LTE sensing information acquired by another transceiver unit of the user equipment or acquired by another UE or acquired by another network entity.

12. User equipment according to claim 1, wherein adaption technique comprises restriction applied depending on one or more of the following criterion:
L1 and/or L2 priority;
cast type;
QOS profile;
HARQ based on blind transmission;
L1 and/or L2 destination IT;
initial transmission or retransmission;
relay traffic or nonrelated traffic;
periodicity; and/or
CBR, total CBR, LTE CBR or an R CBR.

13. User equipment according to claim 1, wherein the UE comprises limited LTE sensing capabilities.

14. User equipment according to claim 1, wherein the UE comprises NR+LTE transceiver or wherein the UE comprises an NR transceiver unit and LTE transceiver unit, especially a NR transceiver unit and LTE transceiver unit which are configured to exchange information using interchange coordination.

15. User equipment according to claim 1, wherein the transceiver is configured to perform LTE sensing (e.g. of potential/future transmissions or past collisions) and to inform an internal NR transceiver unit of the transceiver using interchange coordination or an external NR transceiver using IUC message or broadcasting.

16. User equipment, especially NR user equipment, comprising a transceiver configured for NR communication using an NR resource pool, wherein the transceiver is configured to perform LTE sensing (e.g. of potential/future transmissions or past collisions) and to inform an internal NR transceiver of the transceiver using interchange coordination or an external NR transceiver using IUC message or broadcasting.

17. User equipment according to claim 1, wherein the user equipment is out of the group comprising: a power-limited UE, a hand-held UE, a UE used by a pedestrian, a Vulnerable Road User, VRU, or a Pedestrian UE, P-UE, an on-body or hand-held UE used by public safety personnel and first responders, an IoT UE, a sensor, an actuator or a UE provided in a campus network to carry out repetitive tasks and requiring input from a gateway node at periodic intervals, or a mobile terminal, or a stationary terminal, or a cellular IoT-UE, or a vehicular UE, or a vehicular group leader UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, a sensor or actuator, or any other item or device provided with network connectivity enabling the item/device to communicate using a sidelink the wireless communication network, e.g., a sensor or actuator, or any sidelink capable network entity.

18. Communication system comprising user equipment according to claim 1 using NR resource pool.

19. Method for performing NR communication using an NR resource pool, comprising:
adapting a scheduling for a part of the NR resource pool, wherein adapting the scheduling is performed according to an adaption technique.

20. Non-transitory digital storage medium having stored thereon a computer program for performing a method for performing NR communication using an NR resource pool, comprising:
adapting a scheduling for a part of the NR resource pool, wherein adapting the scheduling is performed according to an adaption technique,
when the computer program is run by a computer.
